(19) United States
(12) Patent Application Publication
(10) Pub. No.: US 2024/0283116 A1
(43) Pub. Date: Aug. 22, 2024

(54) PROTECTOR AND POWER STORAGE MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); TOYOTA JIDOSHA KABUSHIKI KAISHA, Aichi-ken (JP)

(72) Inventors: Hideo TAKAHASHI, Osaka (JP); Kenji KUMAKI, Osaka (JP); Yuki OHIRA, Aichi-ken (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); TOYOTA JIDOSHA KABUSHIKI KAISHA, Aichi-ken (JP)

(21) Appl. No.: 18/426,432

(22) Filed: Jan. 30, 2024

(30) Foreign Application Priority Data
Feb. 20, 2023 (JP) 2023-024408

(51) Int. Cl. H01M 50/591; H01M 50/209; H01M 50/507; H01M 50/588

(52) U.S. Cl. CPC H01M 50/591; H01M 50/209; H01M 50/507; H01M 50/588

(57) ABSTRACT

A protector to be attached to a group of power storage elements that include electrode terminals includes a body portion and cover portions. The body portion includes openings that open in different directions and have opening edges. The cover portions extend from the opening edges of the openings and cover at least portions of the openings. Each of the cover portions includes a base portion, strip portions, and slits. The base portion is connected to the body portion via a hinge portion to be rotatable with respect to the body portion. The strip portions extend from the base portion and are elastically deformable to open a portion of a corresponding one of the openings. The slits are between the strip portions.

### TECHNICAL FIELD

The present disclosure relates to a protector and a power storage module.

### BACKGROUND

A power storage module that is used in an electric automobile or a hybrid automobile includes power storage elements each of which includes a positive electrode terminal and a negative electrode terminal. Adjacent electrode terminals of the adjacent power storage elements are connected by a busbar and the power storage elements are connected in series or in parallel. A battery module described in Japanese Unexamined Patent Application Publication No. 2018-106806 (Patent Document 1) has been known as one example of such a power storage module. The battery module includes a group of cells, busbars that are connected to electrode terminals of the cells, detection wires connected to the busbars, and an insulating protector that holds the busbars and the detection wires.

The insulating protector includes busbar holding portions that store and hold the busbars and protection covers that are configured to cover the busbar holding portions from above. The busbar holding portion includes a rectangular tubular peripheral wall. The peripheral wall includes long side wall portions that extend in an arrangement direction in which the cells are arranged and short side wall portions that extend in a short-length direction of the busbar holding portion. The busbar holding portions that are at two ends in the arrangement direction in which the cells are arranged have openings in the short side wall portions. An external connection busbar that is connected to a positive terminal or a negative terminal of the battery module as a whole can extends outside the battery module through the opening. The external connection busbar can connect two adjacent battery modules or connect the battery module and an external device.

### PRIOR ART

Patent Document 1: Japanese Unexamined Patent Application Publication No. 2018-106806

### SUMMARY

### Problem to be Solved by the Invention

In the battery module of Patent Document 1, the external connection busbar extends outside the battery module in the arrangement direction in which the cells are arranged. However, the external connection busbar may preferably extend outside the battery module in a direction different from the arrangement direction according to the arrangement of the battery modules and the arrangement of the external device. In such a case, another insulating protector having a different shape needs to be produced.

### Means for Solving the Problem

A protector according to the present disclosure is to be attached to a group of power storage elements that include electrode terminals. The protector includes a body portion and cover portions. The body portion includes openings that open in different directions and have opening edges. The cover portions extend from the opening edges of the openings and cover at least portions of the openings. Each of the cover portions includes a base portion, strip portions, and slits. The base portion is connected to the body portion via a hinge portion to be rotatable with respect to the body portion. The strip portions extend from the base portion and are elastically deformable to open a portion of a corresponding one of the openings. The slits are between the strip portions.

A protector according to the present disclosure is to be attached to a group of power storage elements that include electrode terminals. The protector includes a body portion and cover portions. The body portion includes openings that open in different directions and have opening edges. The cover portions extend from the opening edges of the openings and cover at least portions of the openings. Each of the cover portions includes strip portions and slits. The strip portions are elastically deformable to open a portion of a corresponding one of the openings. The slits are between the strip portions.

### Effects

According to the present disclosure, a protector from which an external connection busbar to be connected to an electrode terminal of a power storage element can extend in different directions is provided.

### BRIEF DESCRIPTION OF THE DRAWINGS

FIG. 1 is a plan view of a power storage module according to a first embodiment.

FIG. 2 is a plan view of the power storage module from which a portion of a second protector portion is removed.

FIG. 3 is a perspective view of the power storage module.

FIG. 4 is an enlarged front view of the power storage module.

FIG. 5 is an enlarged side view of the power storage module.

FIG. 6 is a perspective view of a power storage module including a first busbar.

FIG. 7 is a perspective view of a power storage module including a second busbar.

FIG. 8 is a cross-sectional view along A-A line in FIG. 1.

FIG. 9 is a cross-sectional view of the power storage module including the first busbar taken along A-A line in FIG. 1.

FIG. 10 is a cross-sectional view along B-B line in FIG. 1.

FIG. 11 a cross-sectional view of the power storage module including the second busbar taken along B-B line in FIG. 1.

FIG. 12 is a perspective view of a power storage module according to a second embodiment.

FIG. 13 is a cross-sectional view of the power storage module according to a second embodiment taken along A-A line in FIG. 1.

FIG. 14 is a cross-sectional view of the power storage module according to the second embodiment including a third busbar taken along A-A line in FIG. 1.

FIG. 15 is a perspective view of a power storage module according to a third embodiment.

FIG. 16 is a cross-sectional view of a power storage module according to a third embodiment taken along A-A line in FIG. 1.

FIG. 17 is a cross-sectional view of the power storage module according to the third embodiment including a fourth busbar taken along A-A line in FIG. 1.

### DETAILED DESCRIPTION

### Description of Embodiments According to the Present Disclosure

First, embodiments according to the present disclosure will be listed and described.
(1) A protector according to the present disclosure is to be attached to a group of power storage elements that include electrode terminals. The protector includes a body portion and cover portions. The body portion includes openings that open in different directions and have opening edges. The cover portions extend from the opening edges of the openings and cover at least portions of the openings. Each of the cover portions includes a base portion, strip portions, and slits. The base portion is connected to the body portion via a hinge portion to be rotatable with respect to the body portion. The strip portions extend from the base portion and are elastically deformable to open a portion of a corresponding one of the openings. The slits are between the strip portions.

According to such a configuration, with the hinge portion and the strip portions being elastically deformed, the external connection busbar that is connected to the electrode terminal can extend outside through one of the openings. Other one of the openings through which the external connection busbar does not extend can be at least partially covered by the cover portion.
(2) A protector according to the present disclosure is to be attached to a group of power storage elements that include electrode terminals. The protector includes a body portion and cover portions. The body portion includes openings that open in different directions and have opening edges. The cover portions extend from the opening edges of the openings and cover at least portions of the openings. Each of the cover portions includes strip portions and slits. The strip portions are elastically deformable to open a portion of a corresponding one of the openings. The slits are between the strip portions.

According to such a configuration, with the strip portions being elastically deformed, the external connection busbar that is connected to the electrode terminal can extend outside through one of the openings. Other one of the openings through which the external connection busbar does not extend can be at least partially covered by the cover portion.
(3) In the protector described in (1) or (2), each of the cover portions may include a connecting portion that connects extending ends of the strip portions.

According to such a configuration, the strip portions can be collectively deformed.
(4) In the protector described in one of (1) to (3), the strip portions may extend farther away from the corresponding one of the openings as the strip portions extend from the base portion.

According to such a configuration, the strip portions are less likely to be disposed inside the protector through the opening.
(5) The protector described in one of (1) to (4) may further include a first protector portion and a second protector portion that is attached to the first protector portion and includes the cover portions. The openings may be defined by the first protector portion and the second protector portion.

According to such a configuration, the cover portions are easily formed.
(6) A power storage module according to the present disclosure includes the protector described in one of (1) to (5), the group of power storage elements and an external connection busbar that is electrically connected to one of the electrode terminals and extends outside the protector through one of the openings.

According to such a configuration, the power storage module from which the external connection busbar can extend in different directions is provided.

### Details of Embodiments According to the Present Disclosure

Embodiments according to the present disclosure will be described. The present disclosure is not limited to the embodiments. All modifications within and equivalent to the technical scope of the claimed invention may be included in the technical scope of the present invention.

### First Embodiment

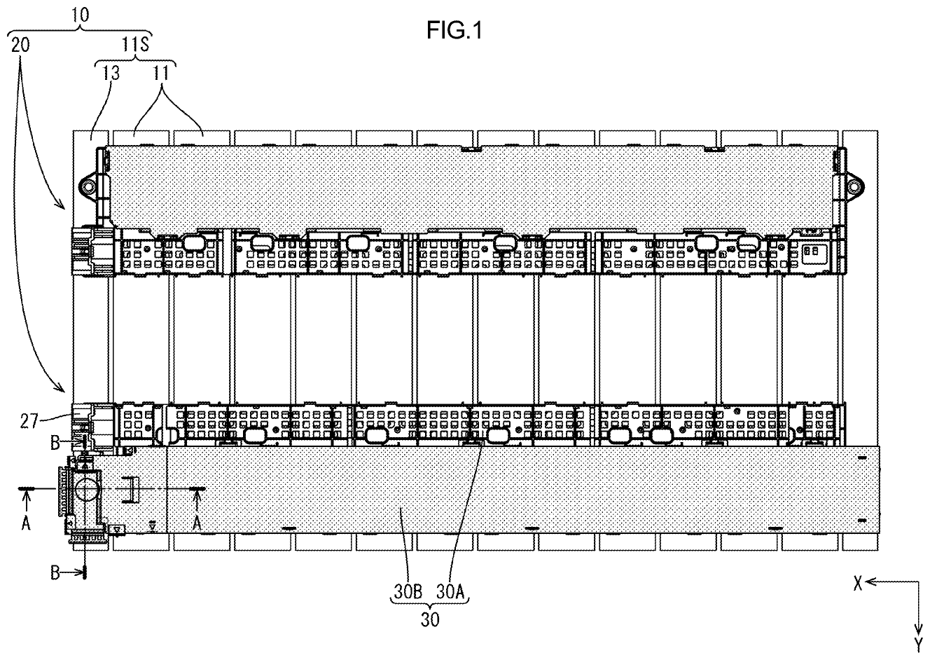

A first embodiment of the present disclosure will be described with reference to FIGS. 1 to 11. A power storage module 10 according to this embodiment is installed in a vehicle as a power source for driving a vehicle such as an electric automobile or a hybrid automobile. In the following description, it is considered that a Z arrow, an X arrow, and a Y arrow point the upper side, the front side, and the left side, respectively. Regarding components having the same configuration, some of the components may be indicated by reference signs and others may not be indicated by the reference signs.

### [Power Storage Module]

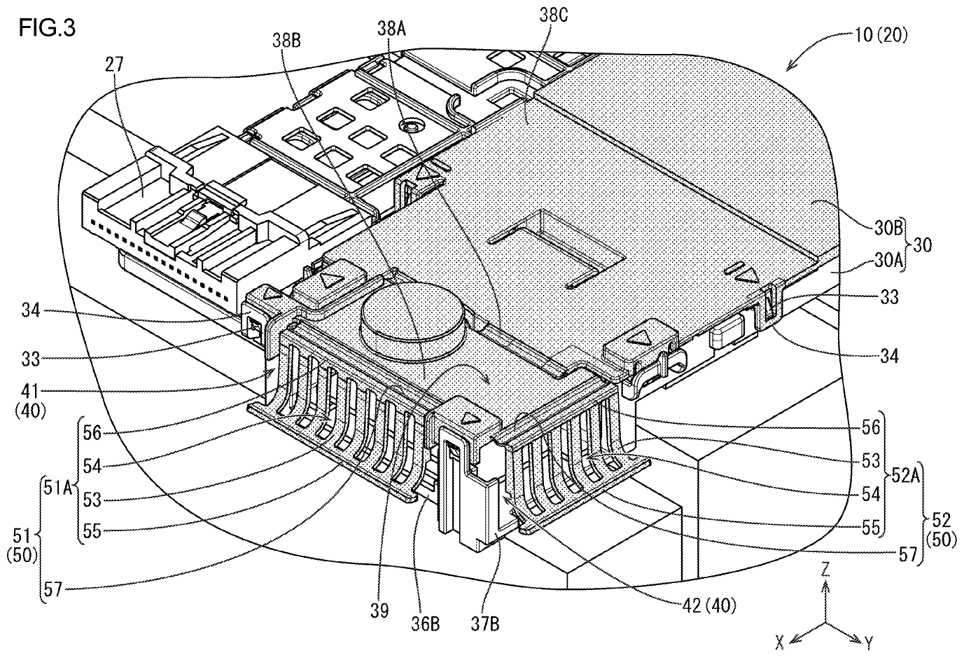

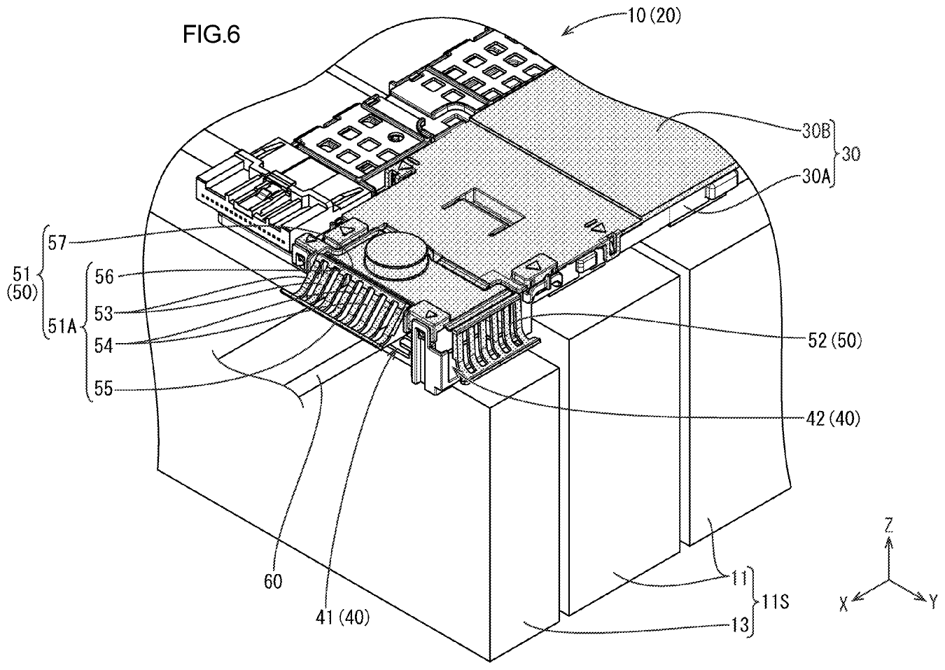

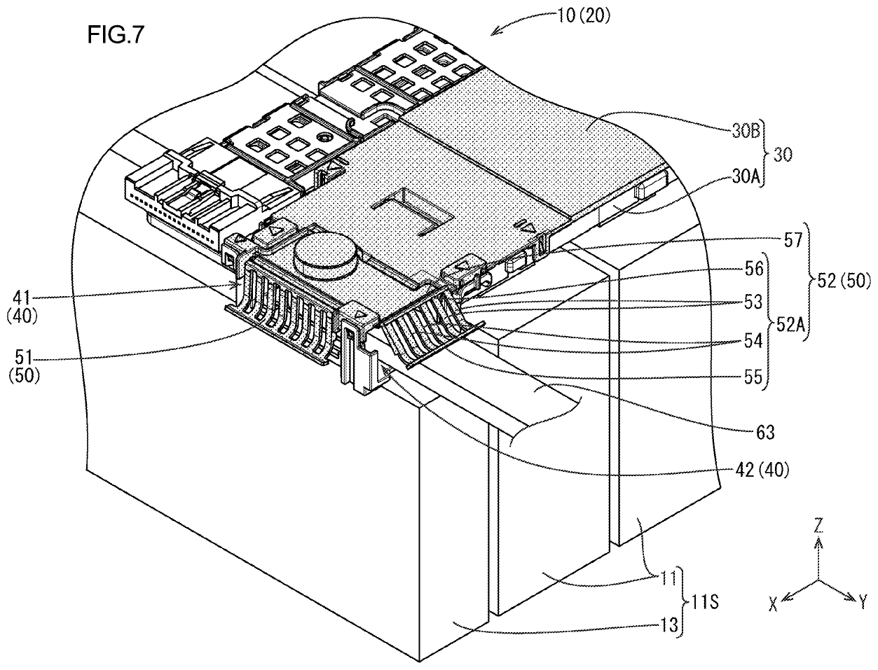

As illustrated in FIG. 1, the power storage module 10 includes a power storage element group 11S and a wiring module 20 that is attached to the power storage element group 11S. As illustrated in FIGS. 3 to 5, the power storage module 10 includes two openings 40 that open in different directions. As will be described later, an external connection busbar can extend outside the power storage module 10 in the different directions through the openings 40 (refer to FIGS. 6 and 7). More in detail, the power storage module 10 can be used with the external connection busbar that extending outside through one of the two openings 40. The power storage module 10 and the wiring module 20 according to this embodiment may not include the external connection busbar (refer to FIG. 3) or may include the external connection busbar (refer to FIGS. 6 and 7).

### [Power Storage Element Group]

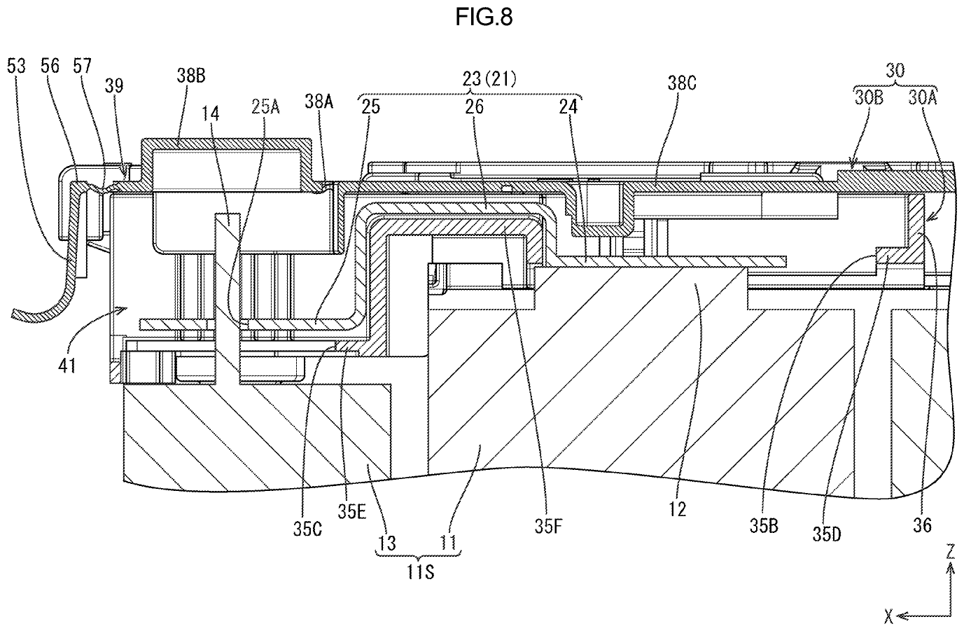

As illustrated in FIG. 1, the power storage element group 11S includes power storage elements 11 that are stacked on each other in a front-rear direction (an X-direction). The power storage elements 11 have a flat rectangular parallelopiped shape and has a small thickness in the front-rear direction. The power storage elements 11 include power storage components therein. The power storage element 11 includes a pair of positive and negative electrode terminals 12 on an upper surface (refer to FIG. 8). A positive electrode terminal 12 and a negative electrode terminal 12 are arranged on the upper surface of the power storage element 11 at an interval with respect to a width direction (a right-left direction, a Y-direction) of the power storage element 11. As illustrated in FIG. 1, the power storage element group 11S includes end plates 13 that sandwich the power storage elements 11 from two ends of the power storage element group 11S with respect to an arrangement direction in which the power storage elements 11 are stacked on each other (the front-rear direction, the X-direction). The end plate 13 is a flat plate having a small thickness in the front-rear direction. As illustrated in FIG. 8, the end plate 13 includes a projection portion 14 that projects from an upper surface.

### [Wiring Module]

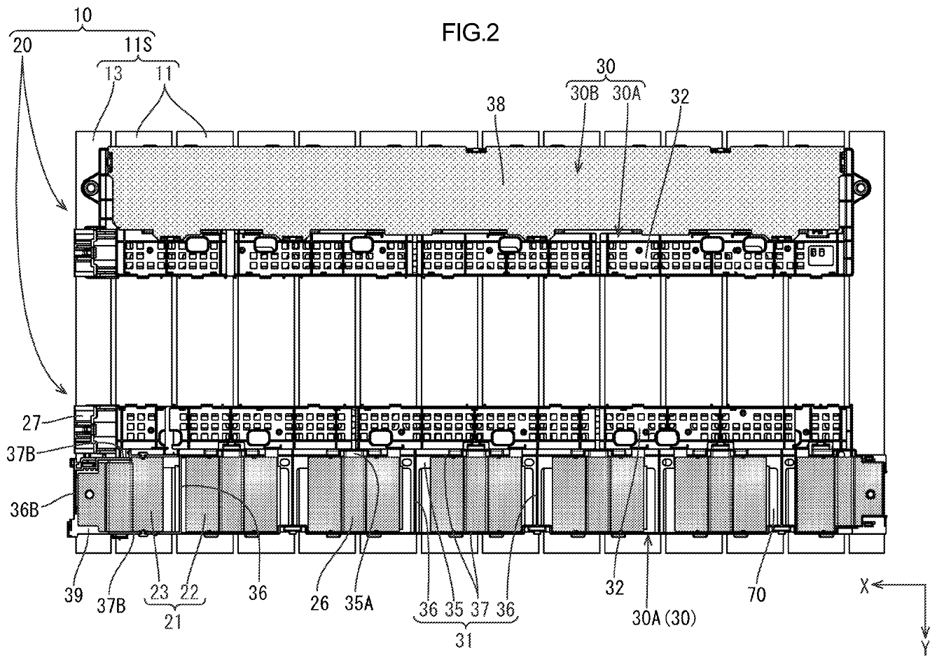

As illustrated in FIG. 2, the wiring module 20 includes busbars 21 and a protector 30 that holds the busbars 21. The busbars 21 include connection busbars 22 that connect adjacent electrode terminals 12 and output busbars 23 each of which is connected to one of the electrode terminals 12 that is configured as a positive terminal or a negative terminal of the power storage element group 11S as a whole. The busbars 21 are formed by processing an electrically conductive metal plate. Each of the busbars 21 has an about rectangular plan view shape. The busbars 21 and the electrode terminals 12 are connected with laser welding.

As illustrated in FIG. 8, the output busbar 23 includes a connection plate portion 24, a fitting plate portion 25, and a joint plate portion 26. The connection plate portion 24 is connected to the electrode terminal 12 that is configured as the positive terminal or the negative terminal of the power storage element group 11S as a whole. The fitting plate portion 25 is disposed on the end plate 13. The joint plate portion 26 connects the connection plate portion 24 and the fitting plate portion 25. The fitting plate portion 25 includes a through hole 25A through which the projection portion 14 is inserted. The joint plate portion 26 has a gate shape in a side view and projects upward with respect to the connection plate portion 24 and the fitting plate portion 25. The connection busbar 22 includes a pair of connection plate portions 24, which are connected to the electrode terminals 12, and the joint plate portion 26 that connects the pair of connection plate portions 24.

A voltage detection wire is connected to each of the busbars 21. The voltage detection wire may be an electric wire or may be a conductive path that is formed on a circuit board such as a flexible printed circuit board. A front end portion of the voltage detection wire is connected to a connector 27 (refer to FIGS. 1 to 3). The connector 27 is to be connected to an electronic control unit (ECU) which is an external device. The ECU has a known configuration including a microcomputer and components and has a function of detecting a voltage, a current, and a temperature of each power storage element 11 and has a function of controlling charging and discharging of each power storage element 11.

### [Protector, First Protector Portion, Second Protector Portion]

The protector 30 is made of synthetic resin having insulating properties. As illustrated in FIG. 2, the protector 30 includes a busbar receiving portion 70 in which the busbars 21 are disposed and a wire receiving portion 32 in which the voltage detection wires are arranged. The protector 30 includes a first protector portion 30A and a second protector portion 30B. The second protector portion 30B is on the opposite side from the power storage elements 11 with respect to the first protector portion 30A. As illustrated in FIG. 3, the first protector portion 30A includes a stopper 33 that projects from an outer surface thereof and the second protector portion 30B includes a stopper receiver 34 that projects from an edge thereof and has a gate shape to be fitted to the stopper 33. With such a configuration, the second protector portion 30B is fixed to the first protector portion 30A.

As illustrated in FIG. 2, the busbar receiving portion 70 includes connection busbar receiving portions 31 in which the connection busbars 22 are disposed and an output busbar receiving portion 39 in which the output busbar 23 is disposed. The connection busbar receiving portion 31 has a frame shape and the connection busbar receiving portions 31 are arranged in the arrangement direction (the front-rear direction) in which the power storage elements 11 are arranged. The connection busbar receiving portion 31 includes a bottom wall 35, a pair of first walls 36, a pair of second walls 37, and a cover wall 38. The bottom wall 35 is disposed between the power storage element 11 and the connection busbar 22. The first walls 36 extend upward from two opposite edges of the bottom wall 35 with respect to the front-rear direction. The second walls 37 extend upward from two opposite edges of the bottom wall 35 with respect to the right-left direction. Each of the second walls 37 extends in the front-rear direction and connects the first walls 36. The cover wall 38 is disposed opposite the bottom wall 35. The first wall 36 may be commonly used for the two connection busbar receiving portions 31 that are adjacent to each other in the front-rear direction. The connection busbar receiving portion 31 further includes a positioning projection portion 35A between the two opposing first walls 36. The positioning projection portion 35A projects upward from the bottom wall 35 and has a curved shape. The positioning projection portion 35A extends along the joint plate portion 26. With such a configuration, the connection busbar 22 is positioned in the connection busbar receiving portion 31. The bottom wall 35, the first walls 36, and the second walls 37 are included in the first protector portion 30A. The cover wall 38 is included in the second protector portion 30B. The connection busbar receiving portion 31 includes portions of the first protector portion 30A and the second protector portion 30B.

As illustrated in FIGS. 2 and 8, the output busbar receiving portion 39 includes a first bottom wall 35D, a second bottom wall 35E, the first wall 36, the positioning projection portion 35F, a front first wall 36B, a pair of second walls 37B, a cover wall 38B, and a cover wall 38C. The first bottom wall 35D is disposed above the power storage element 11. The second bottom wall 35E is disposed between the end plate 13 and the fitting plate portion 25. The first wall 36 extends upward from a rear edge of the first bottom wall 35D. The positioning projection portion 35F is between the first bottom wall 35D and the second bottom wall 35E and projects upward from the first bottom wall 35D and the second bottom wall 35E. The front first wall 36B extends upward from a front edge of the second bottom wall 35E. Each of the second walls 37B extends in the front-rear direction and connects the first wall 36 and the front first wall 36B. The cover wall 38B is disposed opposite the second bottom wall 35E (a portion including a fitting hole 35C). The cover wall 38C is disposed opposite the first bottom wall 35D, the positioning projection portion 35F, and a rear end portion of the second bottom wall 35E. The second bottom wall 35E is disposed lower than the first bottom wall 35D. The front first wall 36B has a dimension measured in the upper-bottom direction (a Z-direction) that is greater than a dimension of the first wall 36 measured in the upper-bottom direction. The second wall 37B has a dimension measured in the upper-bottom direction (the Z-direction) that is greater than a dimension of the second wall 37 measured in the upper-bottom direction. The positioning projection portion 35F extends along the joint plate portion 26. With such a configuration, the output busbar 23 is positioned in the output busbar receiving portion 39. The first bottom wall 35D, the second bottom wall 35E, the first wall 36, the front first wall 36B, and the second walls 37B are included in the first protector portion 30A. The cover walls 38B, 38C are included in the second protector portion 30B. The output busbar receiving portion 39 includes portions of the first protector portion 30A and the second protector portion 30B.

The connection busbar receiving portion 31 and the output busbar receiving portion 39 include connection holes 35B that are through the bottom wall 35 and the first bottom wall 35D. The connection holes 35B are in portions of the bottom wall 35 and the first bottom wall 35D corresponding to the connection plate portions 24 of the connection busbar 22 and the output busbar 23 disposed in the connection busbar receiving portion 31 and the output busbar receiving portion 39. The connection plate portion 24 is connected to the electrode terminal 12 through the connection hole 35B. The output busbar receiving portion 39 in which the output busbar 23 is disposed includes the fitting hole 35C that is through the second bottom wall 35E in the upper-bottom direction. The fitting hole 35C is in a portion of the second bottom wall 35E corresponding to the fitting plate portion 25 of the output busbar 23 that is disposed in the output busbar receiving portion 39. The projection portion 14 of the end plate 13 is inserted in the fitting hole 35C.

As illustrated in FIGS. 3 and 8, a joint portion 38A is connected to the cover wall 38C and a rear edge portion of the cover wall 38B of the output busbar receiving portion 39. The joint portion 38A is thinner than the cover walls 38, 38B, 38C and is elastically deformable. The joint portion 38A extends in the right-left direction along the rear edge portion of the cover wall 38B of the output busbar receiving portion 39. The cover wall 38B of the output busbar receiving portion 39 is pivotable about the joint portion 38A, which extends in the right-left direction, with respect to the cover wall 38C of the output busbar receiving portion 39. According to such a configuration, with the second protector portion 30B being attached to the first protector portion 30A, the fitting of the stopper 33 and the stopper receiver 34, which are provided at the front end portion of the output busbar receiving portion 39, can be released and the cover wall 38B of the output busbar receiving portion 39 can be pivotably moved with respect to the cover wall 38C. Thus, the fitting plate portion 25 of the output busbar 23 and the projection portion 14 of the end plate 13 can be exposed to the outside without completely detaching the second protector portion 30B from the first protector portion 30A (refer to FIG. 8).

As illustrated in FIG. 2, the wire receiving portion 32 is disposed adjacent to the busbar receiving portion 70 with respect to the width direction of the power storage element 11 (the right-left direction) and extends in the arrangement direction in which the power storage elements 11 are arranged (the front-rear direction). The connector 27 is disposed at a front end portion of the wire receiving portion 32.

### [Opening]

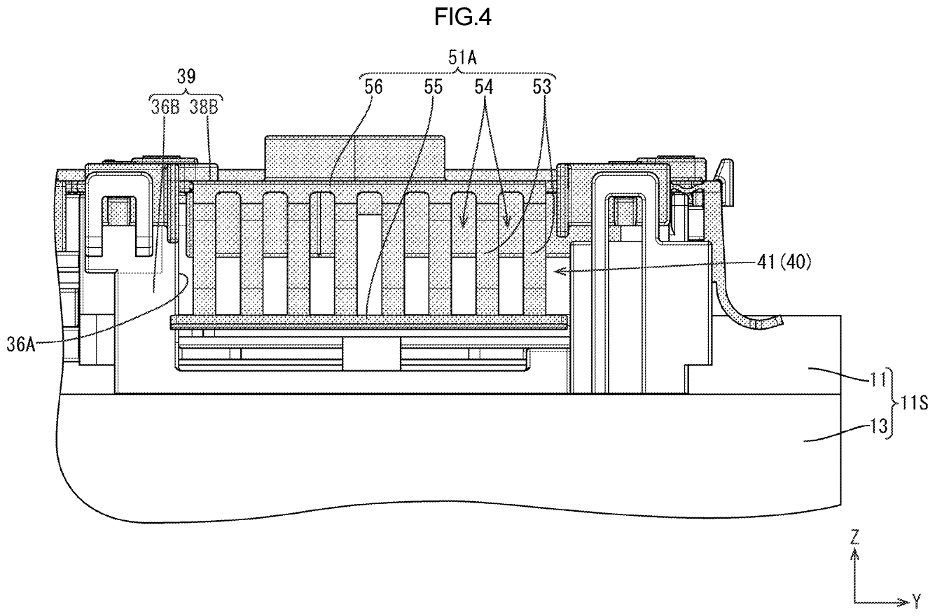

As illustrated in FIG. 3, the output busbar receiving portion 39 (one example of a body portion) includes two openings 40 as previously described. The openings 40 include a first opening 41 and a second opening 42. As illustrated in FIG. 4, the first opening 41 is defined by the cover wall 38B and a first recessed portion 36A that is recessed in the front first wall 36B of the output busbar receiving portion 39. The first opening 41 opens in the arrangement direction in which the power storage elements 11 are arranged (the front-rear direction). An outer side with respect to the first opening 41 corresponds to a direction to be farther away from the power storage element group 11S (a frontward direction) with respect to the front-rear direction in which the first opening 41 opens.

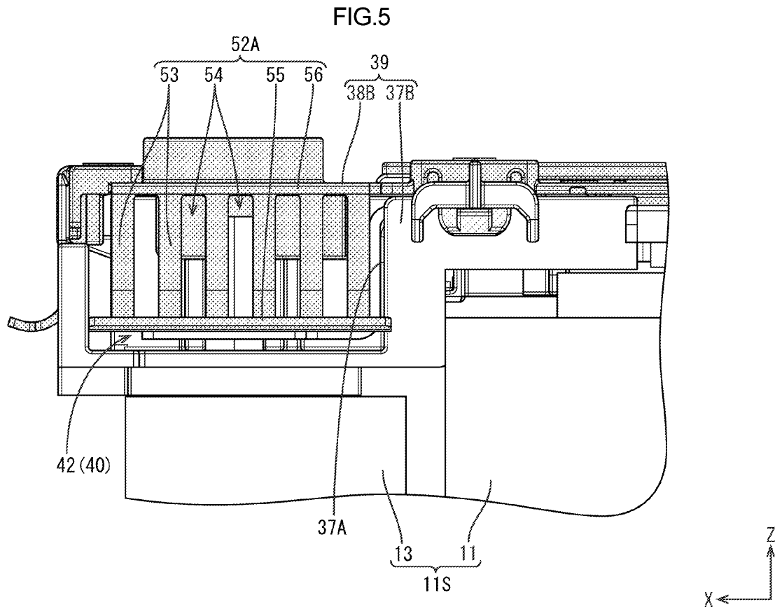

As illustrated in FIG. 5, the second opening 42 is defined by the cover wall 38B and a second recessed portion 37A that is recessed in the left-side second wall 37B of the output busbar receiving portion 39. The second opening 42 opens in the width direction of the power storage element 11 (the right-left direction). An outer side with respect to the second opening 42 corresponds to a direction to be farther away from the power storage element group 11S (a leftward direction) with respect to the right-left direction in which the second opening 42 opens.

The first opening 41 and the second opening 42 are adjacent to one electrode terminal 12 that is configured as the positive terminal or the negative terminal of the power storage element group 11S. As illustrated in FIGS. 6 and 7, the external connection busbar that is electrically connected to the positive terminal or negative terminal of the power storage element group 11S extends outside the wiring module 20 through the first opening 41 or the second opening 42. The external connection busbar is an electrically conductive member that connects the power storage modules 10 or the power storage module 10 and an external device (such as a driving device of a vehicle). The external connection busbar is made of metal such as copper, a copper alloy, aluminum, an aluminum alloy, and stainless steel.

With the above configuration, the external connection busbar can extend outside the power storage module 10 in different directions (the frontward direction or the leftward direction) according to the arrangement of the power storage modules 10 or the arrangement of the power storage module 10 and the external device. Therefore, in the configuration including the power storage modules 10 (for example, a battery pack), the external connection busbar may be necessarily disposed to extend outside in different directions between two power storage modules 10. Even with such a configuration, different types of protectors 30 are unnecessary to be produced corresponding to the extending directions of the external connection busbar. Therefore, a manufacturing cost of the power storage module 10 is likely to be reduced.

### [External Connection Busbar]

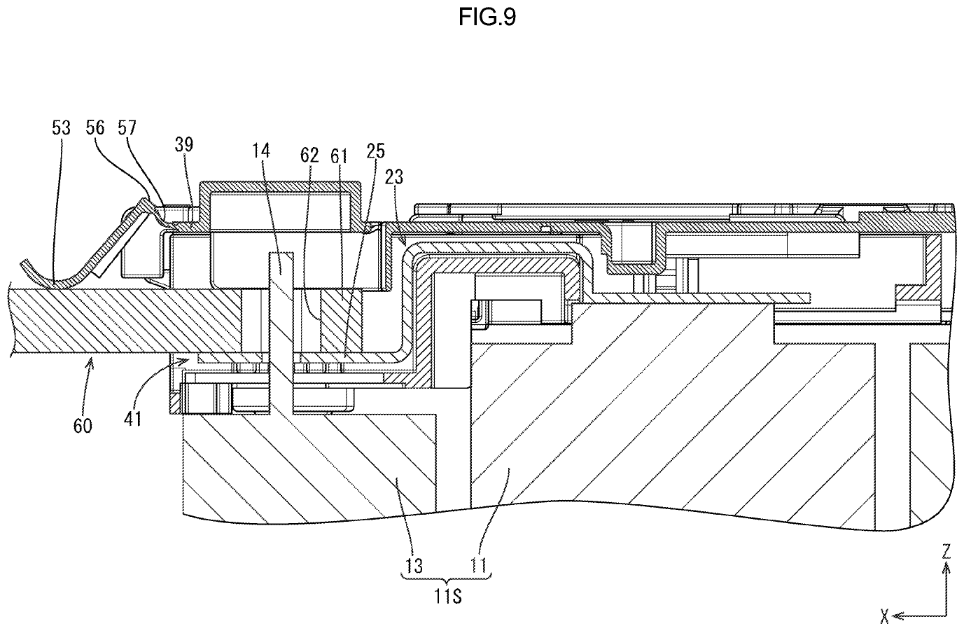

The external connection busbar is connected to the electrode terminal 12 via the output busbar 23. As illustrated in FIG. 9, the external connection busbar extending outside through the first opening 41 is a first busbar 60. The first busbar 60 has a flat plate shape having a small thickness in the upper-bottom direction. The first busbar 60 includes a connection portion 61 that overlaps the fitting plate portion 25 of the output busbar 23 and an insertion hole 62 that is through the connection portion 61 in the upper-bottom direction. The projection portion 14 of the end plate 13 is inserted through the insertion hole 62. The connection portion 61 and the fitting plate portion 25 are electrically connected. For example, the connection portion 61 and the fitting plate portion 25 may be connected as follows. A nut having an internal thread is screwed on the projection portion 14 having an external thread on an outer peripheral surface thereof, and the connection portion 61 is pressed to the fitting plate portion 25. Or the connection portion 61 and the fitting plate portion 25 may be connected with welding.

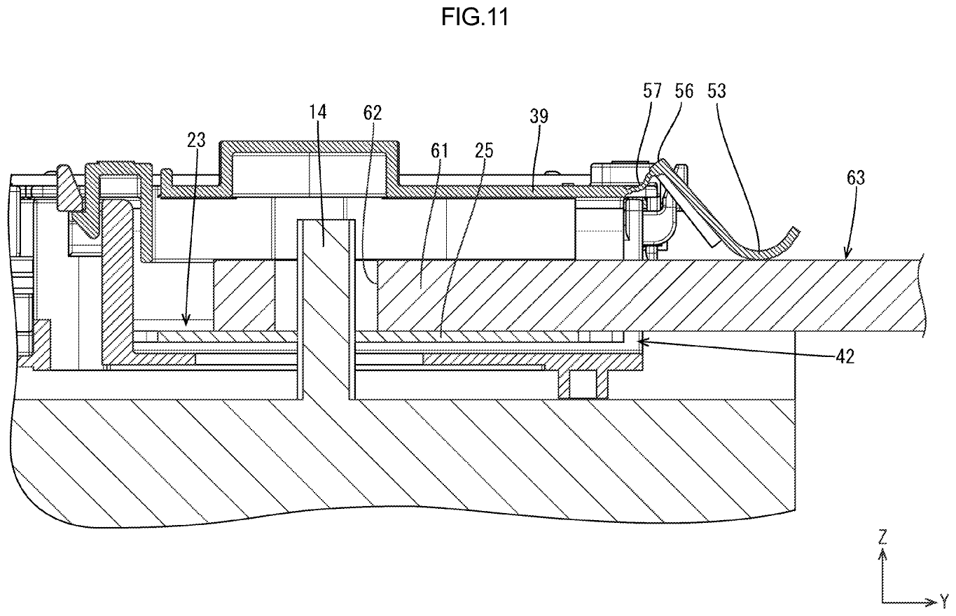

As illustrated in FIG. 11, the external connection busbar extending outside through the second opening 42 is a second busbar 63. The second busbar 63 has a configuration similar to that of the first busbar 60 and includes the connection portion 61 and the insertion hole 62.

### [Cover Portion]

As illustrated in FIG. 3, the protector 30 includes cover portions 50. The cover portions 50 includes a first cover portion 51 and a second cover portion 52. The first cover portion 51 extends from an opening edge of the first opening 41 (a front edge of the cover wall 38B) and is configured to cover a portion of the first opening 41. The second cover portion 52 extends from an opening edge of the second opening 42 (a left edge of the cover wall 38B) and is configured to cover a portion of the second opening 42. The first cover portion 51 and the second cover portion 52 are included in the second protector portion 30B.

### [Hinge Portion, Base Portion, Strip Portions, Slits, Connecting Portion]

The first cover portion 51 includes a cover body portion 51A and a hinge portion 57. The cover body portion 51A is connected to the cover wall 38B via the hinge portion 57. The cover body portion 51A includes a base portion 56, strip portions 53, slits 54, and a connecting portion 55. Eight strip portions 53 extend downward from the base portion 56. Seven slits 54 are between adjacent strip portions 53. The connecting portion 55 connects ends (distal ends) of the strip portions 53 that are opposite ends from the cover wall 38B. The base portion 56 is a bar shape extending in the width direction of the power storage element 11 (the right-left direction). The base portion 56 is connected to the cover wall 38B of the output busbar receiving portion 39 via the hinge portion 57. The cover wall 38B is configured as a portion of the opening edge of the first opening 41. As illustrated in FIG. 8, the hinge portion 57 is thinner than the cover wall 38B and elastically deformable. The base portion 56 is pivotably moved around an axis, which extends in the right-left direction, with respect to the cover wall 38B. The strip portions 53 are elastically deformable with respect to the base portion 56. With the strip portions 53 being elastically deformed, the first opening 41 is partially opened. In other words, the strip portions 53 are elastically deformed to reduce the area of the first opening 41 to be covered by the first cover portion 51. The strip portions 53 are elastically deformed toward the outer side with respect to the first opening 41. With the strip portions 53 being elastically deformed, the area of the first opening 41 to be covered by the first cover portion 51 is reduced in the lower section of the first opening 41.

Unlike this embodiment, the first opening 41 may be covered by a cover portion that does not include the slits 54. However, such a plate-shaped cover portion that does not include the slits is less likely to be elastically deformed compared to the cover portion 50 of this embodiment including the slits 54. Therefore, when the plate-shaped cover portion is deformed to open a portion of the first opening 41, a bending force may particularly concentrate on the hinge portion 57. In this embodiment, with the cover portion 50 including the slits 54 and the hinge portion 57 that is elastically deformable, the strip portions 53 can be elastically deformable.

In a normal state in which the hinge portion 57 and the strip portions 53 are not elastically deformed, most of the opening area of the first opening 41 is covered (refer to FIG. 8). Therefore, when the first busbar 60 does not extend outside through the first opening 41 (for example, when the second busbar 63 extends outside through the second opening 42), the output busbar 23 is less likely to be exposed through the first opening 41. As illustrated in FIGS. 6 and 9, the first busbar 60 extends outside through the first opening 41 by elastically deforming the hinge portion 57 and the strip portions 53.

For example, the first busbar 60 can be disposed to extend outside through the first opening 41 with the following steps. First, the first protector portion 30A holding the busbars 21 is mounted on the power storage element group 11S and the busbars 21 and the electrode terminals 12 are connected. The second protector portion 30B is attached to the first protector portion 30A. The stopper 33 and the stopper receiver 34, which are at the front edge portion of the output busbar receiving portion 39, are not yet fitted to each other. Next, the cover wall 38B of the output busbar receiving portion 39 is pivotably moved with respect to the cover wall 38C such that the fitting plate portion 25 of the output busbar 23 and the projection portion 14 of the end plate 13 are exposed to the outside. The first busbar 60 is inserted through the first recessed portion 36A and the projection portion 14 is fitted through the insertion hole 62. The connection portion 61 is connected to the fitting plate portion 25.

Subsequently, the cover wall 38B of the output busbar receiving portion 39 is moved back to the original position, and the stopper 33 and the stopper receiver 34, which are at the front edge portion of the output busbar receiving portion 39, are fitted together. Then, the strip portions 53 are elastically deformed and the first busbar 60 is stably arranged in the first opening 41. The first busbar 60 is urged by the hinge portion 57 and the strip portions 53 and comes in contact with the strip portions 53 or the connecting portion 55. Therefore, the first opening 41 is not opened outside more than necessary. Thus, the first busbar 60 can extend outside the protector 30 through the first opening 41.

In the above procedure, when the hinge portion 57 and the strip portions 53 urge the first busbar 60, the strip portions 53 are less likely to be elastically deformed independently since the strip portions 53 are connected by the connecting portion 55. For example, portions of the respective strip portions 53 are less likely to be inserted in the first opening 41 (inside the output busbar receiving portion 39, on the rear side with respect to the first opening 41). Therefore, the first busbar 60 is less likely to be exposed to the outside more than necessary.

As illustrated in FIG. 8, the strip portions 53 of the first cover portion 51 extend outward and farther away from the first opening 41 (outside the output busbar receiving portion 39, on the front side with respect to the first opening 41) as the strip portions 53 extend to the distal ends (the connecting portion 55). For example, the strip portions 53 are curved toward the outer side with respect to the first opening 41. The strip portions 53 are curved to be farther away from the first opening 41 as they extend. With such a configuration, the strip portions 53 can be elastically deformed in a desired direction with ease. For example, when the second protector portion 30B is attached to the first protector portion 30A, the strip portions 53 are less likely to be elastically deformed toward the inner side with respect to the first opening 41 or toward the inner side of the output busbar receiving portion 39. Therefore, the output busbar 23 and the first busbar 60 are less likely to be exposed to the outside more than necessary.

With the above configuration, the strip portions 53, the slits 54, and the hinge portion 57 can be formed by removing a die in the upper-bottom direction. Therefore, the second protector portion 30B can be formed with a simple die.

The second cover portion 52 has a configuration similar to the configuration of the first cover portion 51 and therefore, the same components as those of the first cover portion 51 may be indicated by the same reference signs. As illustrated in FIG. 5, the second cover portion 52 includes a cover body portion 52A and the hinge portion 57. The cover body portion 52A is connected to the cover wall 38B via the hinge portion 57. The cover body portion 52A includes the base portion 56, the strip portions 53, the slits 54, and the connecting portion 55. Five strip portions 53 extend downward from the base portion 56. Four slits 54 are between adjacent strip portions 53. The connecting portion 55 connects ends (distal ends) of the strip portions 53. The hinge portion 57 and the strip portions 53 are elastically deformable.

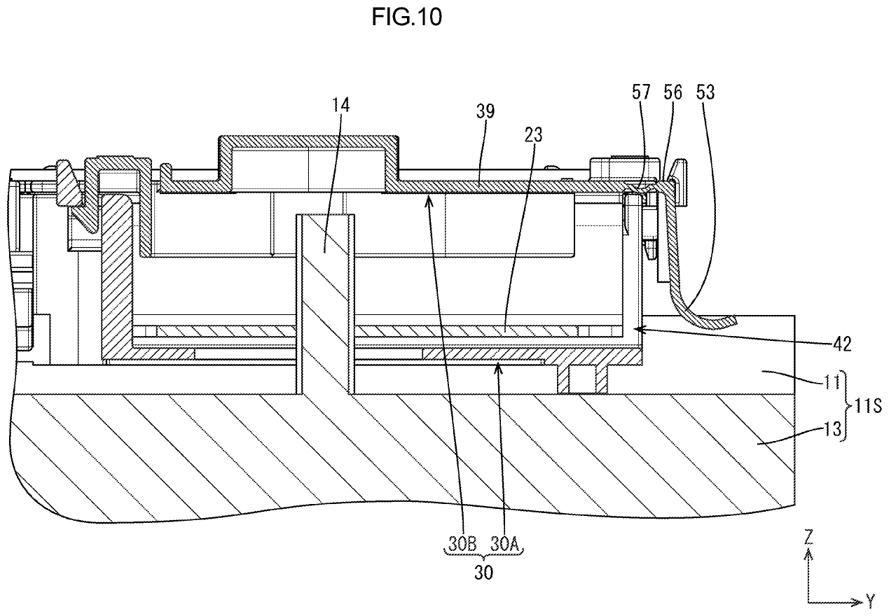

In a normal state in which the hinge portion 57 and the strip portions 53 are not elastically deformed, most of the opening area of the second opening 42 is covered (refer to FIG. 10). Therefore, when the second busbar 63 does not extend outside through the second opening 42 (for example, when the first busbar 60 extends outside through the first opening 41), the output busbar 23 is less likely to be exposed through the second opening 42. As illustrated in FIGS. 7 and 11, with the hinge portion 57 and the strip portions 53 being elastically deformed, the second busbar 63 extends outside through the second opening 42. The steps with which the second busbar 63 is disposed to extend through the second opening 42 are similar to the steps with which the first busbar 60 extends through the first opening 41.

As illustrated in FIG. 10, the strip portions 53 of the second cover portion 52 extend outward and farther away from the second opening 42 (outside the output busbar receiving portion 39, on the left side with respect to the second opening 42) as the strip portions 53 extend to the distal ends (the connecting portion 55). For example, the strip portions 53 are curved toward the outer side with respect to the second opening 42. The strip portions 53 are curved to be farther away from the second opening 42 as they extend. With such a configuration, the strip portions 53 can be elastically deformed in a desired direction with ease. For example, when the second protector portion 30B is attached to the first protector portion 30A, the strip portions 53 are less likely to be elastically deformed toward the inner side with respect to the second opening 42 or toward the inner side of the output busbar receiving portion 39. Therefore, the output busbar 23 and the second busbar 63 are less likely to be exposed to the outside more than necessary.

### [Operations and Effects of First Embodiment]

According to the first embodiment, operations and effects described below are obtained.

The protector 30 according to the first embodiment is to be attached to the power storage element group 11S. The power storage element group 11S includes the power storage elements 11 having the electrode terminals 12. The protector 30 includes a body portion (the output busbar receiving portion 39) and the cover portions 50. The body portion includes the openings 40 that open different directions. The cover portions 50 extend from opening edges of the openings 40 of the body portion and cover at least portions of the respective openings 40. Each of the cover portions 50 includes the base portion 56, the strip portions 53, and the slits 54. The base portion 56 is rotatably connected to the body portion via the hinge portion 57. The strip portions 53 extend from the base portion 56 and are elastically deformable to open a portion of each opening 40. The slits 54 are between the adjacent strip portions 53.

According to such a configuration, with the hinge portion 57 and the strip portions 53 being elastically deformed, the external connection busbar (the first busbar 60, the second busbar 63) that is connected to the electrode terminal 12 can extend outside through one of the openings 40. Other one of the openings 40 through which the external connection busbar does not extend can be at least partially covered by the cover portion 50.

In the first embodiment, each of the cover portions 50 includes the connecting portion 55 that connects the distal end portions of the strip portions 53.

According to such a configuration, the strip portions 53 can be collectively deformed.

In the first embodiment, the strip portions 53 extend outward and farther away from the openings 40 as they extend toward the distal ends.

According to such a configuration, the strip portions 53 are less likely to be disposed inside the protector 30 through the opening 40.

The protector 30 according to the first embodiment includes the first protector portion 30A and the second protector portion 30B that is attached to the first protector portion 30A. The openings 40 are defined by the first protector portion 30A and the second protector portion 30B and the second protector portion 30B includes the cover portions 50.

According to such a configuration, the cover portions 50 are easily formed.

The power storage module 10 according to the first embodiment includes the protector 30, the power storage element group 11S, and the external connection busbar that is electrically connected to the electrode terminal 12 and extends outside the protector 30 through one of the openings 40.

According to such a configuration, the power storage module 10 from which the external connection busbar can extend in different directions is provided.

### Second Embodiment

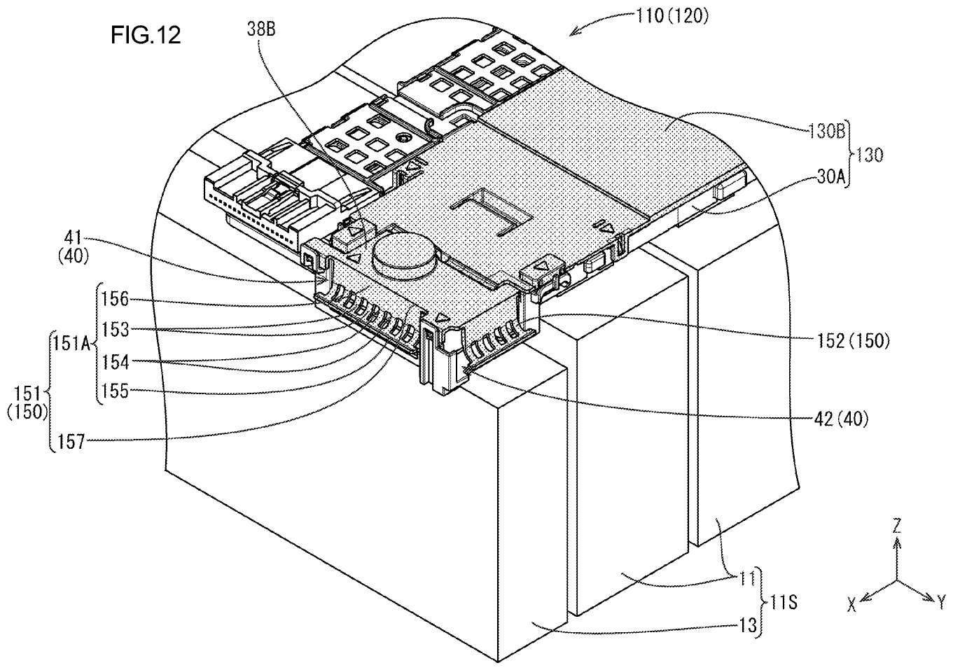

A second embodiment of the present disclosure will be described with reference to FIGS. 12 to 14. As illustrated in FIG. 12, a power storage module 110 according to the second embodiment includes a wiring module 120 and the power storage element group 11S. A protector 130 of the wiring module 120 according to the second embodiment includes the first protector portion 30A, which is same as that of the first embodiment, and a second protector portion 130B. The second protector portion 130B has a configuration similar to that of the second protector portion 30B of the first embodiment except for the configuration of cover portions 150. In the following description, components having the same configurations as those of the first embodiment and operations and effects same as those of the first embodiment may not be described. Regarding components having the same configuration, some of the components may be indicated by reference signs and others may not be indicated by the reference signs.

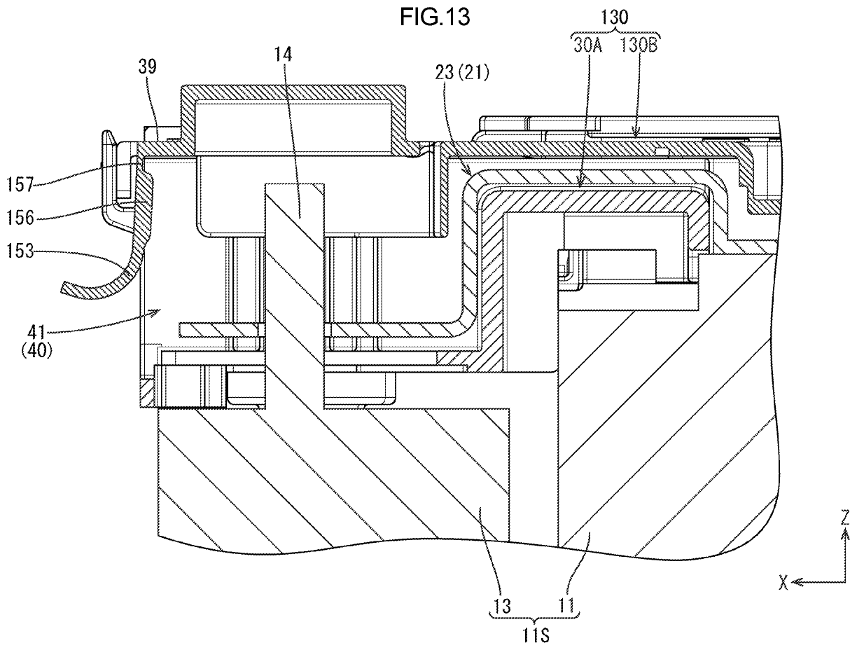

The cover portions 150 of the second protector portion 130B includes a first cover portion 151 and a second cover portion 152. The first cover portion 151 includes a cover body portion 151A and a hinge portion 157. The cover body portion 151A is connected to the cover wall 38B via the hinge portion 157. The cover body portion 151A includes a plate portion 156 (one example of the base portion), strip portions 153, slits 154, and a connecting portion 155. Eight strip portions 153 extend from the plate portion 156 and are elastically deformable. Seven slits 154 are between adjacent strip portions 153. The connecting portion 155 connects distal ends of the strip portions 153. As illustrated in FIG. 13, the plate portion 156 is a flat plate having a small thickness in the arrangement direction in which the power storage elements 11 are arranged (the front-rear direction). The plate portion 156 is connected to the cover wall 38B of the output busbar receiving portion 39 via the hinge portion 157. The cover wall 38B is configured as a portion of the opening edge of the first opening 41. The hinge portion 157 is elastically deformable. The plate portion 156 is pivotably moved around an axis, which extends in the width direction of the power storage element 11 (the right-left direction), with respect to the cover wall 38B.

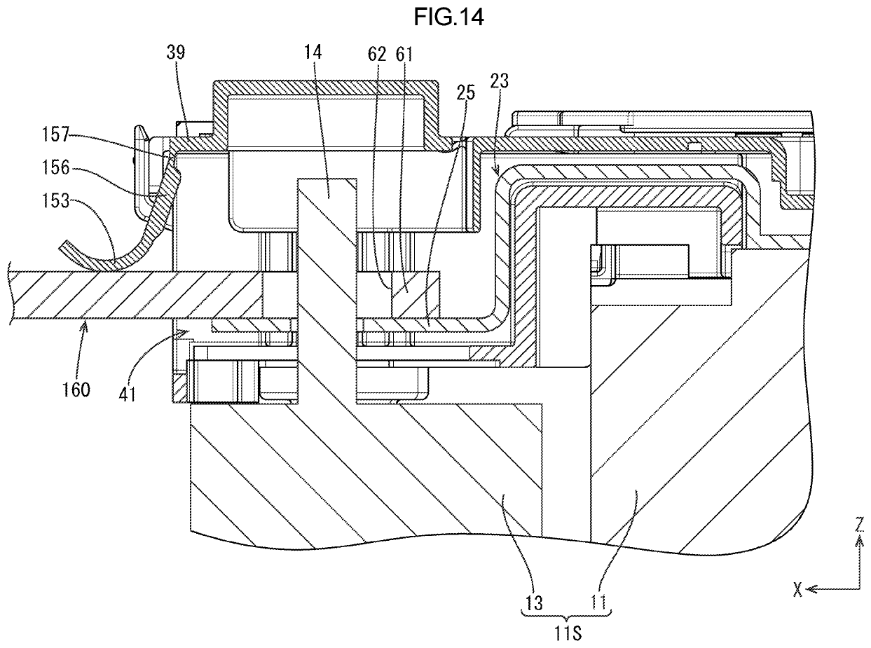

In a normal state in which the hinge portion 157 and the strip portions 153 are not elastically deformed, most of the opening area of the first opening 41 is covered. As illustrated in FIG. 14, with the hinge portion 157 and the strip portions 153 of the first cover portion 151 being elastically deformed, a third busbar 160, which is one example of the external connection busbar, extends outside through the first opening 41. The third busbar 160 is urged by the hinge portion 157 and the strip portions 153 and comes in contact with the strip portions 153 or the connecting portion 155. Therefore, the first opening 41 is not opened outside more than necessary.

The second cover portion 152 has a configuration similar to the configuration of the first cover portion 151. The second cover portion 152 includes a cover body portion and the hinge portion 157. The cover body portion includes the plate portion 156, five strip portions 153, four slits 154, and the connecting portion 155 (refer to FIG. 12). The second cover portion 152 that is in a normal state can cover a portion of the second opening 42. With the hinge portion 157 and the strip portions 153 of the second cover portion 152 being elastically deformed, the external connection busbar can extend outside through the second opening 42.

In this embodiment, the plate portion 156 is longer in the upper-bottom direction than the base portion 56 of the first embodiment. Therefore, the first cover portion 150 can cover a larger area of each opening 40 than the cover portion 50 of the first embodiment.

### Third Embodiment

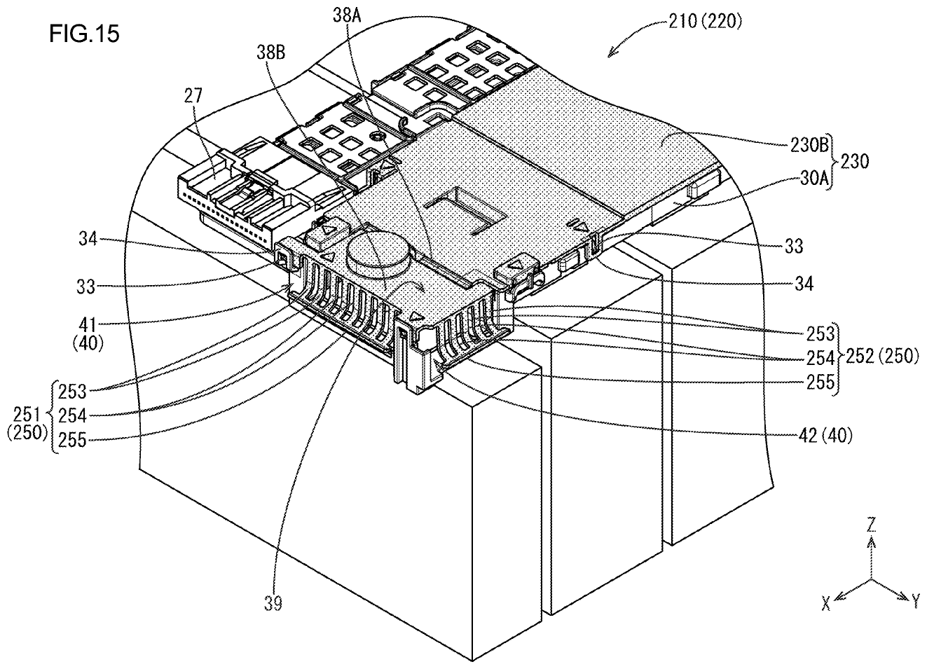

A third embodiment of the present disclosure will be described with reference to FIGS. 15 to 17. As illustrated in FIG. 15, a power storage module 210 according to the third embodiment includes a wiring module 220 and the power storage element group 11S. A protector 230 of the wiring module 220 according to the third embodiment includes the first protector portion 30A, which is same as that of the first embodiment, and a second protector portion 230B. The second protector portion 230B has a configuration similar to that of the second protector portion 30B of the first embodiment except for the configuration of cover portions 250. In the following description, components having the same configurations as those of the first embodiment and operations and effects same as those of the first embodiment may not be described. Regarding components having the same configuration, some of the components may be indicated by reference signs and others may not be indicated by the reference signs.

The cover portions 250 of the second protector portion 230B includes a first cover portion 251 and a second cover portion 252. The first cover portion 251 includes strip portions 253, slits 254, and a connecting portion 255. Eight strip portions 253 extend downward from the cover wall 38B. Seven slits 254 are between adjacent strip portions 253. The connecting portion 255 connects distal ends of the strip portions 253. The strip portions 253 are elastically deformable with respect to the cover wall 38B. With the strip portions 253 being elastically deformed, a portion of the first opening 41 is opened. In detail, the strip portions 253 can be elastically deformed outward from the first opening 41.

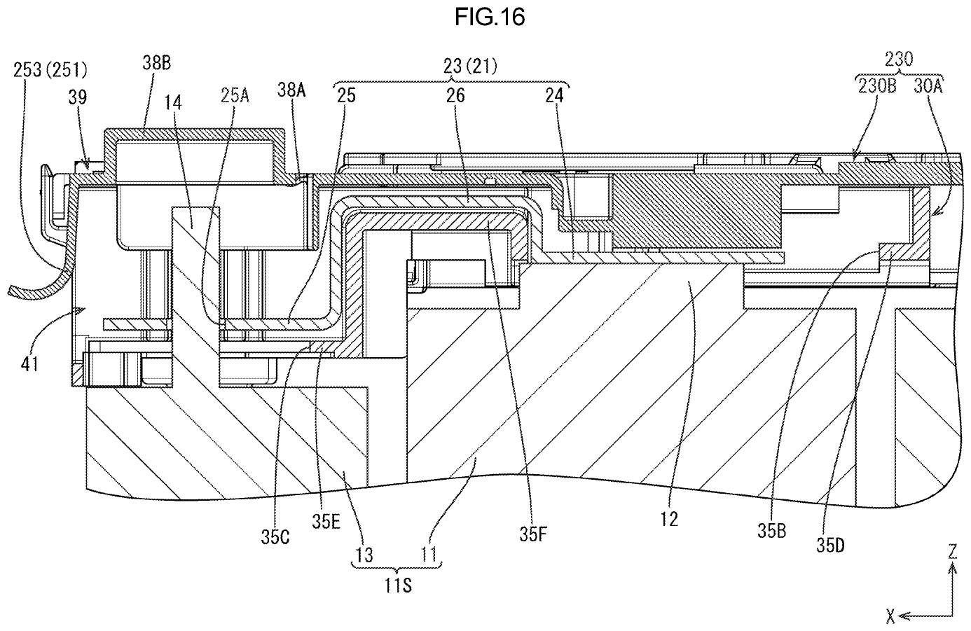

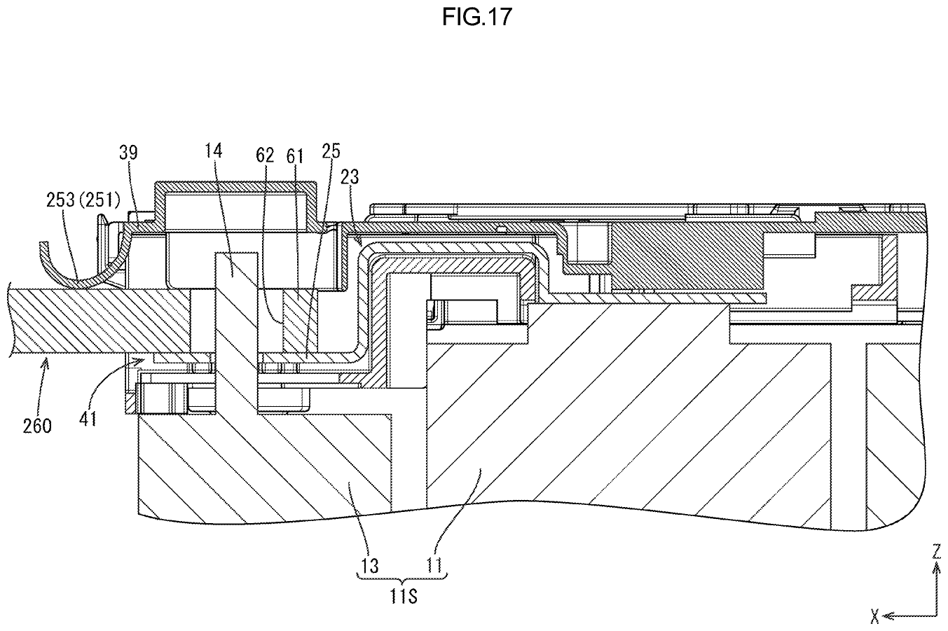

As illustrated in FIG. 16, in a normal state in which the strip portions 253 are not elastically deformed, most of the opening area of the first opening 41 is covered. As illustrated in FIG. 17, with the strip portions 253 of the first cover portion 251 being elastically deformed, a fourth busbar 260, which is one example of the external connection busbar, extends outside through the first opening 41. The fourth busbar 260 is urged by the strip portions 253 and comes in contact with the strip portions 253 or the connecting portion 255. Therefore, the first opening 41 is not opened outside more than necessary.

The second cover portion 252 has a configuration similar to the configuration of the first cover portion 251. The second cover portion 252 includes five strip portions 253, four slits 254, and the connecting portion 255. The second cover portion 252 that is in a normal state can cover a portion of the second opening 42. With the strip portions 253 of the second cover portion 252 being elastically deformed, the external connection busbar can extend outside through the second opening 42.

In the third embodiment, unlike the first and second embodiments, the cover portions 250 do not include a hinge portion and a base portion. Therefore, the cover portions 250 of the second protector portion 230B can be formed more easily.

### [Operations and Effects of Third Embodiment]

According to the third embodiment, operations and effects described below are obtained.

The protector 230 according to the third embodiment is to be attached to the power storage element group 11S. The power storage element group 11S includes the power storage elements 11 having the electrode terminals 12. The protector 230 includes the body portion (the output busbar receiving portion 39) and the cover portions 250. The body portion includes the openings 40 that open different directions. The cover portions 250 extend from opening edges of the openings 40 of the body portion and cover at least portions of the respective openings 40. Each of the cover portions 250 includes the strip portions 253 and the slits 254. The strip portions 253 are elastically deformable to open a portion of each opening 40. The slits 254 are between the adjacent strip portions 253.

According to such a configuration, with the strip portions 253 being elastically deformed, the external connection busbar (the fourth busbar 260) that is connected to the electrode terminal 12 can extend outside through one of the openings 40. Other one of the openings 40 through which the external connection busbar does not extend can be at least partially covered by the cover portion 250.

### Other Embodiments

(1) In the first to third embodiments, the protector includes two openings 40 but may include three or more openings.
(2) In the first to third embodiments, the first opening 41 opens in the arrangement direction in which the power storage elements 11 are stacked on each other and the second opening 42 opens in the width direction of the power storage element 11. However, the opening directions of the openings may be altered as necessary.
(3) Unlike the protectors 30, 130, 230 of the first to third embodiments, the protector may be a unitary component.
(4) In the first to third embodiments, the protector includes the connecting portion 55, 155, 255 but may not include the connecting portion.
(5) In the first to third embodiments, the external connection busbar (the first busbar 60, the second busbar 63, the third busbar 160, the fourth busbar 260) is connected to the electrode terminal 12 via the output busbar 23 but may be directly connected to the electrode terminal.

### EXPLANATION OF SYMBOLS

10, 110, 210: power storage module
11: power storage element
11S: power storage element group
12: electrode terminal
13: end plate
14: projection
20, 120, 220: wiring module
21: busbar
22: connection busbar
23: output busbar
24: connection plate portion
25: fitting plate portion
25A: through hole
26: joint plate portion
27: connector
30, 130, 230: protector
30A: first protector portion
30B, 130B, 230B: second protector portion
31: connection busbar receiving portion
32: wire receiving portion
33: stopper
34: stopper receiver
35: bottom wall
35A: positioning projection portion
35B: connection hole
35C: fitting hole
36: first wall
36A: first recessed portion
37: second wall
37A: second recessed portion
38: cover wall
38A: joint portion
39: output busbar receiving portion (body portion)
40: opening
41: first opening
42: second opening
50, 150, 250: cover portion
51, 151, 251: first cover portion
52, 152, 252: second cover portion
53, 153, 253: strip portion
54, 154, 254: slit
55, 155, 255: connecting portion
56: base portion
57, 157: hinge portion
60: first busbar (external connection busbar)
61: connection portion
62: insertion hole
63: second busbar (external connection busbar)
156: plate portion (base portion)
160: third busbar (external connection busbar)
260: fourth busbar (external connection busbar)

1. A protector to be attached to a group of power storage elements that include electrode terminals, the protector comprising:
a body portion including openings that open in different directions and have opening edges; and
cover portions extending from the opening edges of the openings and covering at least portions of the openings, each of the cover portions includes
a base portion that is connected to the body portion via a hinge portion to be rotatable with respect to the body portion,
strip portions extending from the base portion and being elastically deformable to open a portion of a corresponding one of the openings, and
slits that are between the strip portions.

2. The protector according to claim 1, wherein each of the cover portions includes a connecting portion that connects extending ends of the strip portions.

3. The protector according to claim 1, wherein the strip portions extend farther away from the corresponding one of the openings as the strip portions extend from the base portion.

4. The protector according to claim 1, further comprising:
a first protector portion; and
a second protector portion attached to the first protector portion and including the cover portions, wherein
the openings are defined by the first protector portion and the second protector portion.

5. A power storage module comprising:
the protector according to claim 1;
the group of power storage elements; and
an external connection busbar that is electrically connected to one of the electrode terminals and extends outside the protector through one of the openings.

6. A protector to be attached to a group of power storage elements that include electrode terminals, the protector comprising:
a body portion including openings that open in different directions and have opening edges; and
cover portions extending from the opening edges of the openings and covering at least portions of the openings, each of the cover portions including
strip portions that are elastically deformable to open a portion of a corresponding one of the openings, and
slits that are between the strip portions.

7. The protector according to claim 6, wherein each of the cover portions includes a connecting portion that connects extending ends of the strip portions.

8. The protector according to claim 6, wherein the strip portions extend farther away from the corresponding one of the openings as the strip portions extend from the base portion.

9. The protector according to claim 6, further comprising:
a first protector portion; and
a second protector portion attached to the first protector portion and including the cover portions, wherein
the openings are defined by the first protector portion and the second protector portion.

10. A power storage module comprising:
the protector according to claim 6;
the group of power storage elements; and
an external connection busbar that is electrically connected to one of the electrode terminals and extends outside the protector through one of the openings.
